(19) United States
(12) Patent Application Publication
(10) Pub. No.: US 2019/0085776 A1
(43) Pub. Date: Mar. 21, 2019

(54) DIESEL TO NATURAL GAS CONVERSION SYSTEM

(71) Applicant: American Gas & Technology, Dallas, OR (US)

(72) Inventors: Raymon E. Tate, JR., Dallas, OR (US); Michael R.L. Tate, Dallas, OR (US); Thomas A. Tate, Isleton, CA (US); William J. Briskey, Monmouth, OR (US)

(21) Appl. No.: 16/113,614

(22) Filed: Aug. 27, 2018

Related U.S. Application Data
(60) Provisional application No. 62/551,495, filed on Aug. 29, 2017.

(51) Int. Cl. F02D 41/00; F02D 19/06; F02D 19/08; F02M 21/02

(52) U.S. Cl. CPC F02D 41/0027; F02D 19/0623; F02M 21/0275; F02D 19/066; F02D 19/081; F02D 19/0647

(57) ABSTRACT

A dual-fuel conversion system that introduces natural gas into at least one engine cylinder and replaces diesel fuel with a replacement pilot fuel for ignition. The system includes replacement injectors that mount to an injector adapter that replaces the original diesel fuel injector, a control computer that is reprogrammed to control timing of the replacement injectors, and replacement fuel components to distribute natural gas and a pilot fuel to the at least one engine cylinder.

### BACKGROUND

The present application relates to internal combustion engine fuel systems and more particularly diesel engine fuel conversion systems.

Natural gas has a long history as a power source. Power plants commonly burn natural gas to produce electrical power, and it sees use in energizing water heaters, home furnaces, stoves, clothes dryers, and other applications. It accounts for approximately a quarter of all energy consumption in the United States at the present time.

Natural gas is a comparatively inexpensive fuel source as compared to other common fuel sources like gasoline. A gasoline gallon equivalent (GGE) of natural gas presently costs around a dollar in many parts of the country, less than half of the cost of a gallon of gasoline. The world's supply of natural gas is also very large, and is expected to last well into the next century based on current consumption trends; as such, natural gas is expected to remain relatively cheap for the near future. Further, a significant quantity of natural gas is produced domestically, and this quantity has been increasing in recent years with the advent of new fracking techniques that have allowed previously-unviable domestic reserves to be tapped; natural gas use thus reduces reliance on foreign oil and has been promoted for this reason.

Natural gas is also comparatively environmentally friendly, as compared to other fossil fuels in use today. Natural gas, as extracted in nature, is typically a composition of methane, ethane, propane, butane, and pentane, as well as various other compounds such as carbon dioxide, sulfur, and water vapor. Most of the other compounds are removed in the refining process, leaving methane as the primary component. Because methane is composed of only one carbon atom and four hydrogen atoms, it burns relatively cleanly, with complete combustion of a methane molecule yielding one carbon dioxide molecule and two water molecules. This means that methane has lower greenhouse emissions than almost any other fuel in use today, apart from hydrogen.

As such, there has been an increasing drive to replace other fossil fuels in current use with natural gas in order to take advantage of its low cost and relative cleanliness. One of the largest trends in power production has been the growth of natural gas or coal gasification plants to replace coal-fired power plants. This has significant effects on emissions, particularly when coupled with other processes such as carbon-capture technology.

Historically, natural gas-powered vehicles have largely been restricted to a few bus fleets and hobbyists. (For example, natural gas vehicles have enjoyed some popularity among survivalists and those in remote rural areas because methane, the key component in natural gas, can be produced from a home-based methane generator using decomposing organic matter. This has meant that, should there be any interruption in the fuel supply, the hobbyist still theoretically has the ability to refuel their vehicle.)

The limited number of natural gas vehicles has not changed for several reasons. A first reason has been the lack of necessity; existing infrastructure is in place to serve gasoline-powered vehicles rather than natural gas-powered ones, and with gasoline being relatively cheap, there has been no clear reason to switch from one to the other. As such, there are only a limited number of public refueling stations across the country. The majority of these stations tend to be clustered in just a few states, like New York, California, Oregon, Utah, and Texas; 16 states appear to have no public natural gas fueling sites whatsoever. This lack of demand for natural gas vehicles has also meant a lack of supply; few major vehicle manufacturers offer an OEM natural gas-based vehicle for sale in the United States, and as such, the only way for most people to obtain a car that works on natural gas has been to convert an existing automobile.

Conversion has also historically been expensive. While modifying a gasoline-powered vehicle to run on natural gas is not particularly technically challenging—the existing gasoline engine can often be used without significant modification, though may be subject to increased engine wear. The US has stringent legislation (passed as part of the Clean Air Act) that prohibits the modification of fuel systems. A violation of this act can cost a consumer up to $5000 in fines for every day that they drive the converted vehicle. In order to comply with the Act, consumers must go to a certified compressed-natural-gas (CNG) installer in order to perform the conversion; certified installers are somewhat rare and can charge high prices to do the conversion.

A second reason has been due to certain difficulties involved with storing and pumping natural gas, and the relatively low volumetric energy density of natural gas. Natural gas is typically transported and stored in one of two forms, compressed natural gas (CNG) and liquefied natural gas (LNG). Compressed natural gas has a volumetric energy density about 25% that of diesel fuel. Liquified natural gas achieves a much higher reduction in volume than compressed natural gas (around 2.4 times that of CNG, or around 60% that of diesel fuel) but must be stored at extremely low temperatures in specialized cryogenic tanks, meaning that most conversion systems have so far been designed for CNG.

CNG tanks must be pressurized up to about 3600 psi in order to obtain the advertised volumetric energy density. However, a National Fire Protection Association safety standard bans the use of compressed natural gas storage in homes and home natural gas is delivered at a very low pressure of around 0.5 psi. This means that to fill a natural gas vehicle at home, a stand-alone multistage compressor pump generally must be hooked up to the vehicle's fuel tank and the gas compressed into the vehicle itself. Therefore, fueling the vehicle can take many hours. This pump is also relatively expensive (typically several thousand dollars), which has further meant that it has historically been unattractive to switch to natural gas for cost reasons.

As such, the vast majority of the natural gas vehicle market in the United States is through public transit agencies operating fleets of natural gas-powered buses, with the remainder being mostly hobbyist-focused. Natural gas vehicle refueling stations do not have the restrictions imposed by the National Fire Association so can take advantage of pre-compressed fuel (CNG) at their stations. Vehicle fleets can refuel overnight in their fleet yards by using specialized compressors.

Due to the continued concern about diesel and gasoline emissions and despite the past challenges of natural gas, the interest in natural gas-powered vehicles continues to increase. In particular, some diesel fuel engine manufacturers and some aftermarket manufacturers have been experimenting with natural gas conversions for existing diesel engines, whether as “dedicated” or “dual fuel” systems. A small number of purpose-built OEM natural gas engines are also in use, which may be installed in vehicles as they are being manufactured or may be installed in existing vehicles as a retrofit.

A “dedicated” system is a diesel engine that has been fully converted to a spark-ignition engine, which allows the diesel engine to operate only using natural gas. Such systems are more effective in reducing emissions and diesel fuel use than “dual-fuel” systems. However, these conversions are complex and expensive, can at present only be performed on a limited selection of engines, so are usually purchased new in very small quantities.

A “dual-fuel” system retains the diesel fuel system and uses it as a sort of “liquid spark plug” or “pilot.” A diesel engine is constructed to withstand high cylinder pressures because diesel combusts (without a spark) once it reaches a minimal pressure and temperature. Natural gas requires a higher ignition temperature than diesel fuel and so needs help to get it to combust in a diesel engine, even under high pressure. Adding some diesel fuel to the mix in the cylinder will initiate combustion (like a pilot light in a gas furnace or water heater) and ignite the natural gas. Therefore, vehicles with dual-fuel systems use diesel fuel (though in a reduced quantity) throughout their duty cycles. For example, a dual-fuel vehicle is started with a mix of almost 100% diesel, and natural gas then replaces some of the diesel in the mixture depending on the load felt by the engine. In operation, a small amount of diesel fuel is injected first to act as a pilot, and then natural gas is injected in order to provide the bulk of the power for the vehicle. Such systems are less effective in reducing emissions than dedicated conversion systems because some quantity of diesel fuel must still be burned in order to ignite the natural gas. However, it is much less expensive and complex to convert an engine to a dual-fuel system than convert a diesel to a dedicated system, and the dual-fuel conversion can be installed in a wider variety of engines.

One of the most common natural gas engine systems in use today is the Westport top dead center injector dual-fuel system, known as the “High-Pressure Direct Injection” (HPDI) system. This device incorporates an injector that is able to inject natural gas into the cylinder when the cylinder is at top dead center, at the end of the compression stroke. This allows small quantities of diesel fuel and large quantities of natural gas to be delivered at high pressure to the combustion chamber. This device replaces a significant quantity of the diesel fuel (by energy) with natural gas, by using the diesel fuel only to ignite the natural gas. This results in significant emissions reductions over a pure diesel fuel system, but still burns enough diesel fuel to be undesirable from an emissions perspective—the diesel percentage of the mix can, under favorable conditions, be as low as 5%, but is typically closer to 30% under higher load conditions. Further reduction of this ratio has historically been difficult, as below this ratio, the pilot fuel or “liquid spark plug,” i.e. the diesel in the fuel mixture, may not burn hot enough to light the natural gas present in the mixture.

Accordingly, there is a need for a dual-fuel system that is not so limited.

### SUMMARY

The conversion system of the present application operates on the premise that if diesel as a pilot fuel can be replaced by a different fuel, it may be possible to further reduce emissions in an engine designed originally to operate on diesel fuel. For example, gasoline may offer both a much cleaner burn when combined with appropriate emissions filtering (i.e. catalytic converter), and it requires far less gasoline to initiate combustion of compressed natural gas than diesel. There might be other fuels that can replace diesel and provide the benefits desired.

A dual-fuel system is disclosed, which in some exemplary embodiments may be used to reduce the ratio of pilot fuel to natural gas. In some exemplary embodiments, such a system may be incorporated into a diesel engine as a conversion, and diesel fuel may be used in some quantity; in other exemplary embodiments, such a system may make use of another pilot fuel other than diesel fuel, such as, for example, gasoline, propane, or lacquer thinner. This may result in a significant reduction of pilot fuel usage relative to the main fuel, possibly even less than 1% depending on the pilot and main fuels used.

According to an exemplary embodiment of a dual-fuel system, a diesel engine may be provided having a glow plug in the combustion chamber, onto which an existing fuel injector may be configured to spray. Such a diesel engine may be converted to a natural gas engine by using a conversion system as disclosed herein.

In an exemplary embodiment, the glow plug may be removed from the diesel engine and may be replaced with a fuel injector. In some exemplary embodiments, this may entail, for example, installing an adapter in the place of the glow plug, and installing the fuel injector in the adapter. The glow plug fuel injector may then be coupled to a pilot fuel tank and may be configured to dispense the pilot fuel.

In an exemplary embodiment, the existing fuel injector of the diesel engine may then be replaced with a natural gas injector that may be installed in its place. The natural gas injector may be coupled to a natural gas source (typically originating from a tank of compressed or liquid natural gas) and may be configured to dispense natural gas at some point in the engine cycle. For example, according to an exemplary embodiment of an engine, natural gas may be dispensed through the fuel injector when the diesel cylinder is at top dead center, before full compression (e.g., up to 15 degrees); in another exemplary embodiment of an engine, natural gas may be dispensed through the fuel injector at another position, as may be desired.

According to another exemplary embodiment, instead of the replacement of the glow plug with a second fuel injector for pilot fuel, the second fuel injector may be installed in the head of the diesel cylinder. In some exemplary embodiments, such a fuel injector may be used in addition to a glow plug fuel injector, which may allow, for example, the injection of pilot fuels from multiple locations or may allow the injection of multiple different pilot fuels, as may be desired. In another embodiment, three injectors are used: one for each fuel and a third to send the combined mixture into the combustion chamber. The timing of the dual fuel injector opening and dwell periods may be very different than diesel as a pilot fuel will ignite and burn at different pressures and temperatures. For example, if gasoline were used for a pilot fuel, it would be introduced into the cylinder later than diesel would because it ignites at lower temperature and burns faster than diesel. For example, the pilot fuel injector may be activated within +/−2 degrees of top dead center (TDC) and stay open for less than 200 microseconds. Furthermore, natural gas could be injected into the cylinder for example, as early as 15 degrees before TDC and the injector stay open 5 degrees after TDC. Timing for both fuels would be adjusted for each engine in response to current conditions such as when the engine is idling, under load, or cold, ambient temperature, pressure, and humidity and also to meet performance and emissions goals.

In an exemplary embodiment, a pilot fuel may be selected such that the pilot fuel spontaneously combusts when injected into the combustion chamber, which may operate at a high temperature, for example 450 degrees Fahrenheit. For example, according to an exemplary embodiment, gasoline, propane, lacquer thinner, or any other fuel may be used because each has a spontaneous combustion temperature below the anticipated operating temperature of the diesel engine combustion chamber, and no further ignition of the pilot fuel may be required.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of an existing diesel fuel injection system.

FIG. 2 is an exemplary embodiment of a diesel fuel injection system having the glow plug removed.

FIG. 3 is an exemplary embodiment of a diesel fuel injection system that has been converted to a natural gas/pilot fuel system.

FIG. 4 is an exemplary embodiment of an existing diesel fuel injection system and cylinder head.

FIG. 5 is an exemplary embodiment of a diesel fuel injection system and cylinder head that has been converted to a natural gas/pilot fuel system.

FIG. 6 is an exemplary embodiment of a system diagram for an existing diesel fuel injection system.

FIG. 7 is an exemplary embodiment of a system diagram for a diesel fuel injection system that has been converted to a natural gas/pilot fuel system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring generally to the Figures, various exemplary implementations of a conversion system for converting a diesel engine to a pilot-fuel-fired natural gas engine may be disclosed.

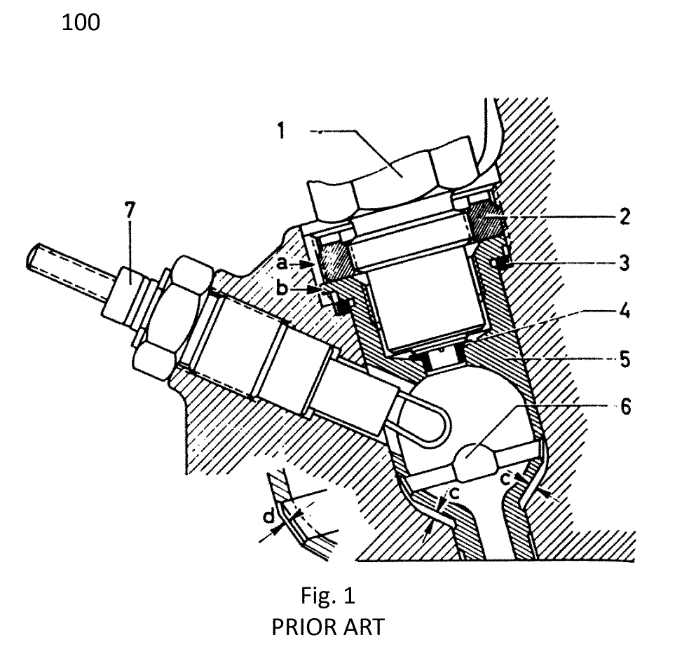

Turning now to exemplary FIG. 1, FIG. 1 displays an exemplary embodiment of an existing diesel fuel injection system 100. According to an exemplary embodiment, a diesel fuel injection system 100 may include a groove in the cylinder head, a, in which the various other components of the diesel fuel injection system 100 may be disposed; a lug, b, used to secure the prechamber 5; a nozzle holder 1; a threaded ring 2 disposed around the top of the prechamber 5; a seal ring 3 disposed between the prechamber 5 and the cylinder head; a seal ring 4 disposed between the prechamber 5 and the nozzle holder 1; a prechamber 5, which in this case may be a ball pin prechamber 5; a ball pin 6 disposed in the prechamber 5; and a glow plug 7.

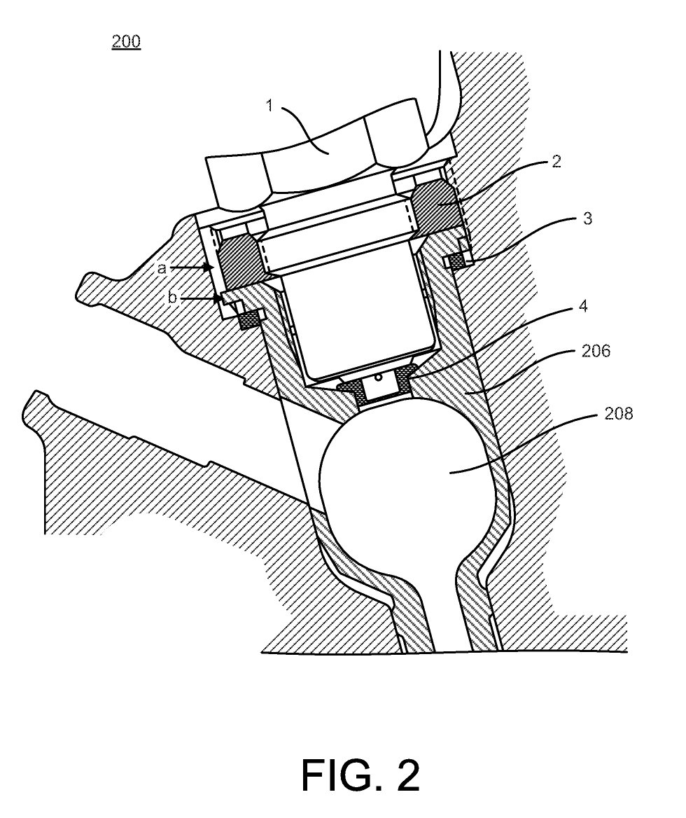

Turning now to exemplary FIG. 2, FIG. 2 displays an exemplary embodiment of a diesel fuel injection system 200 having a glow plug 7 removed and FIG. 1 prechamber 5 removed and replaced with an adapter/pre-combustion insert 206. The insert 208 shape will be configured to direct fuel flow dispersion for optimal distribution and combustion. In an exemplary embodiment, a glow plug 7 or the prechamber 5 may be removed during a conversion process.

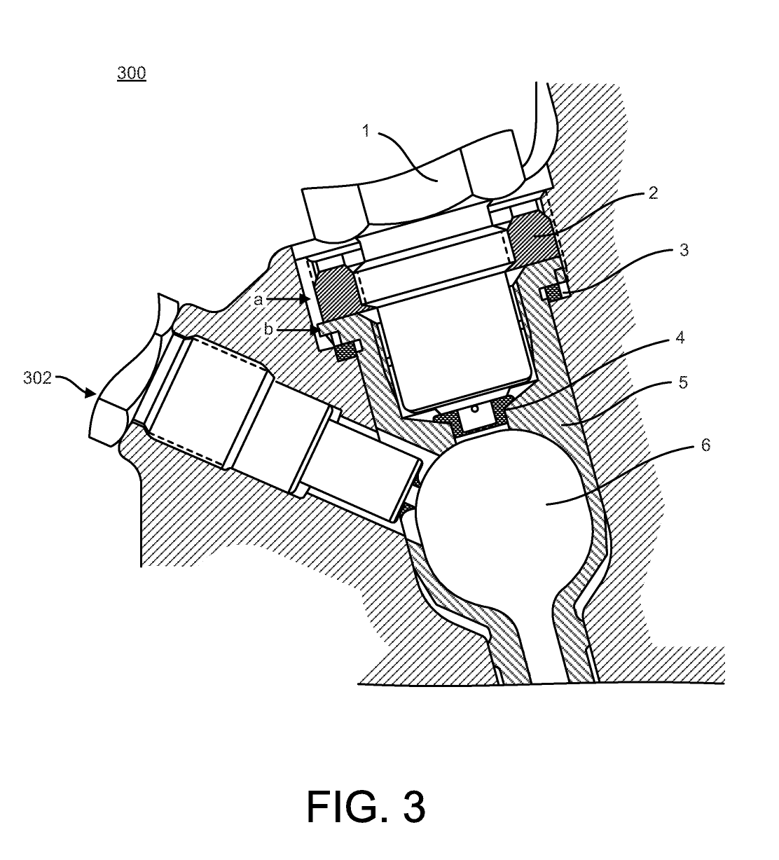

Turning now to exemplary FIG. 3, FIG. 3 displays an exemplary embodiment of a diesel fuel injection system 300 that has been converted to a natural gas/pilot fuel system. According to an exemplary embodiment, a prechamber 5 may be removed and replaced by an adapter/pre-combustion insert and a first fuel injector may be replaced by a natural gas-specific fuel injector. In a next step, a glow plug 7 may be replaced by a second fuel injector 302 which may, like the first fuel injector, face downward into the adapter/pre-combustion insert. In an exemplary embodiment, an adapter may first be installed in the glow plug 7 hole in order to better retain the second fuel injector 302 in the glow plug 7 hole. In another exemplary embodiment, a second fuel injector 302 may be approximately the same size as a glow plug 7 (for example, a second fuel injector 302 may be engine-specific or may be shaped to replace a particular glow plug 7 or set of glow plugs 7) and may be installed into the glow plug 7 hole without the use of an adapter, such as may be desired.

Very large engines, such as marine engines, may benefit from an addition of more than one hole for the addition of multiple new injectors. Another embodiment may include removing the diesel fuel injectors and replacing each with first an injector adapter, into which an injector may be installed. In some cases, the injector may not need an adapter.

In an exemplary embodiment, the first and the second fuel injector 302 may be coupled to a natural gas source and a small pilot fuel tank. For example, according to an exemplary embodiment, the second fuel injector 302 (which may be the pilot fuel injector) may be coupled to a small pilot fuel tank and the first fuel injector (which may be the natural gas fuel injector) may be coupled to a natural gas source, such as may be desired.

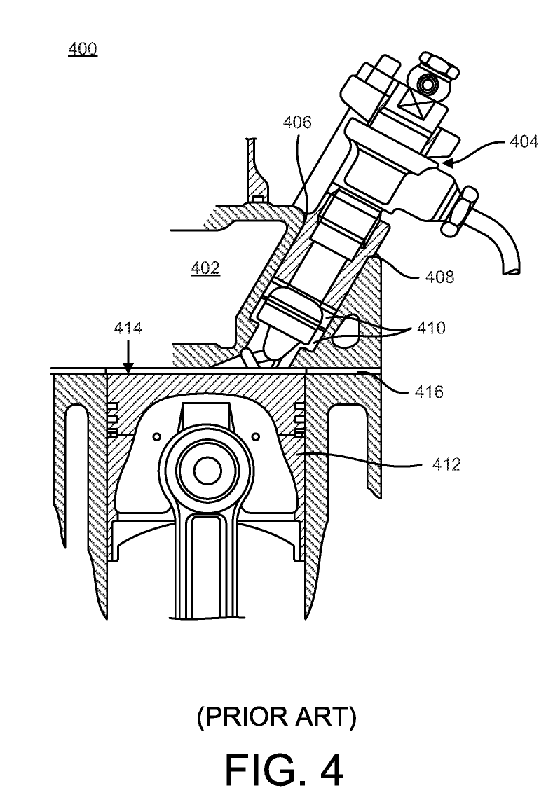

Turning next to exemplary FIG. 4, FIG. 4 displays an exemplary embodiment of an existing diesel fuel injection system 400 and cylinder head such as might be found in existing diesel engines. According to an exemplary embodiment, an exemplary embodiment of an existing diesel fuel injection system 400 and cylinder head 402 may have a fuel injector 404, may have an O-ring 406 spaced around the fuel injector 404, may have a nozzle nut 408 used to secure the fuel injector 404 in place, may have a prechamber 410 disposed at the distal end of the fuel injector 404, and may have a piston 412 designed to operate within the cylinder and extend upwards toward the cylinder head 402. In an exemplary embodiment, the piston 412 may have a top clearance 414 that is equal to the piston deck height plus the thickness of the compressed head gasket 416.

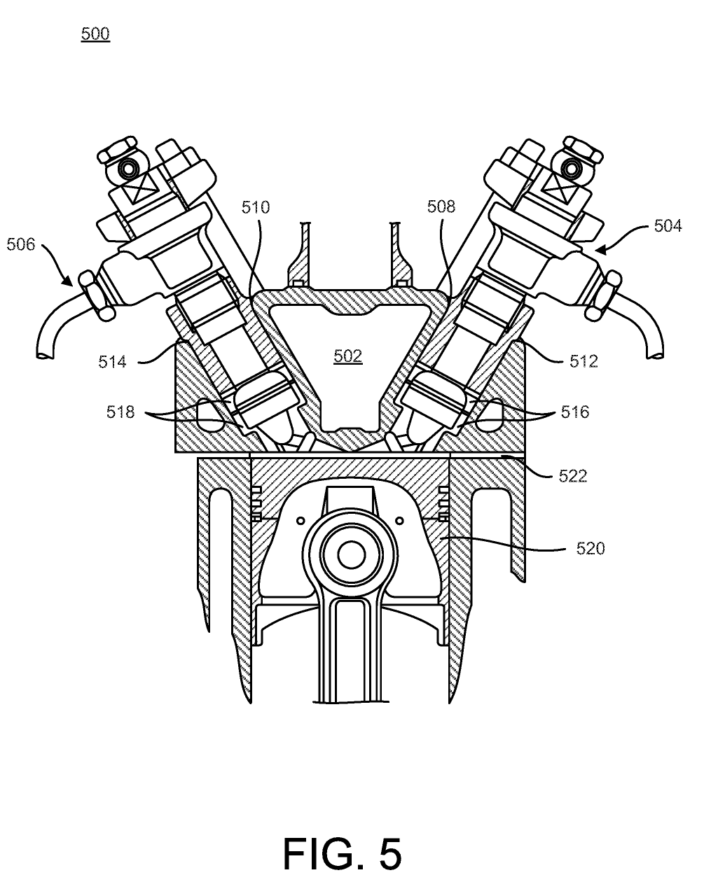

Turning next to exemplary FIG. 5, FIG. 5 displays an exemplary embodiment of a diesel fuel injection system 500 and cylinder head 502 that has been converted to a natural gas/pilot fuel system. According to an exemplary embodiment, a cylinder head 502 may be replaced with a cylinder head 502 specifically intended to be used with two fuel injectors; in another exemplary embodiment, a cylinder head 502 may be modified in order to accept two fuel injectors, for example by a user tapping into the cylinder head 502 in order to install the second fuel injector into the cylinder head 502.

For example, according to an exemplary embodiment, a first fuel injector 504 may be installed and may be coupled to a natural gas source, and a second fuel injector 506 may be installed and coupled to a pilot fuel tank. In some exemplary embodiments, the order may be reversed such that the first fuel injector 504 is coupled to a pilot fuel tank and such that the second fuel injector 506 is coupled to a natural gas source, if desired. According to an exemplary embodiment, the first and the second fuel injector 504, 506 may each have an O-ring 508, 510, may each have a nozzle nut 512, 514, and may each have an adapter/pre-combustion insert 516, 518 installed at the distal end of each respective fuel injector 504, 506. The combustion chamber may further have a piston 520 which may extend almost all of the way up to the cylinder head 502 when fully extended; as before, the top clearance of the piston 520 may be equal to the piston deck height plus the thickness of the compressed head gasket 522.

The timing and duration of the pilot, natural gas, and main injector are controlled by a central processing unit (CPU) or processor to feed the optimal mixture into the cylinder. Sample timing and duration are provided in Table A below for gasoline-CNG dual-fuel engines. As can be appreciated, the operating parameters will vary depending on the types of fuels being used, however, the timing sequence differs as compared to a diesel pilot dual fuel engine. The differences in these parameters may be implemented with supplemental CPU that piggybacks onto the vehicle CPU for timing of the first and second fuel injectors.

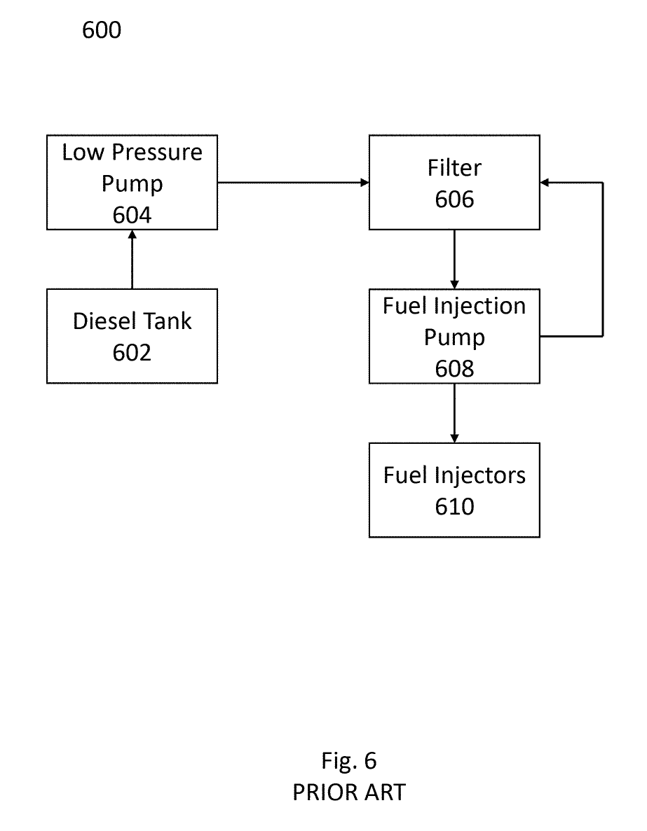

Turning now to exemplary FIG. 6, FIG. 6 displays an exemplary embodiment of a system diagram for an existing diesel fuel injection system 600. In an exemplary embodiment, diesel fuel may be provided in a diesel tank 602. In a next step, the diesel fuel in the diesel tank 602 may be extracted using a low pressure pump 604. The diesel fuel may then be passed through a filter 606, and then into a fuel injection pump 608, where it may then be pumped out through the fuel injectors 610. In an exemplary embodiment, residual diesel fuel in the fuel injection pump 608 may then be passed through the filter 606 again and back into the fuel injection pump 608.

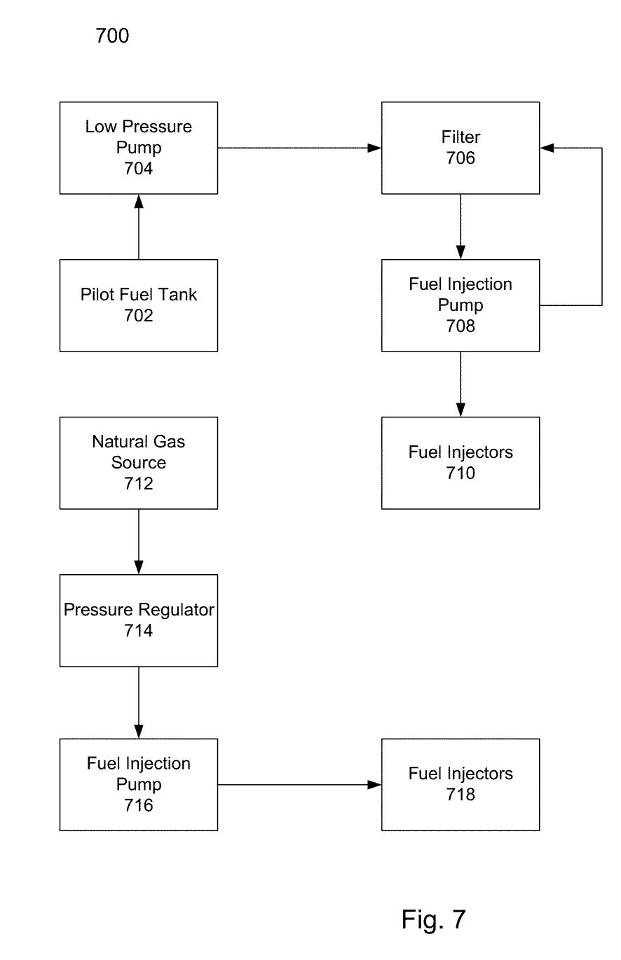

Turning now to exemplary FIG. 7, FIG. 7 displays an exemplary embodiment of a system diagram for a diesel fuel injection system 700 that has been converted to a natural gas/pilot fuel system. In an exemplary embodiment, a pilot fuel system may be installed having essentially the same components as the previous diesel fuel system 600 previously used to inject fuel into the engine; in an exemplary embodiment, fuel may be provided in a pilot fuel tank 702. In a next step, the pilot fuel in the pilot fuel tank 702 may be extracted using a low pressure pump 704, for example, at 45 psi in the case of gasoline. The pilot fuel may then be passed through a filter 706, and then into a fuel injection pump 708, where it may then be pumped out through the fuel injectors 710, for example, at 5000 psi in the case of gasoline. In an exemplary embodiment, residual fuel in the fuel injection pump 708 may then be passed through the filter 706 again and back into the fuel injection pump 708.

Simultaneously, the natural gas/pilot fuel system may have a natural gas source 712 from which natural gas may be dispensed. In an exemplary embodiment, the natural gas source may dispense natural gas through a pressure regulator 714, which may be fed first to the fuel injection pump 716 and then to the fuel injectors 718. In an exemplary embodiment, the natural gas source may be compressed natural gas or it may be liquefied natural gas. In an exemplary embodiment the temperature of the high-pressure natural gas may be monitored as it is distributed to each injector. In an exemplary embodiment the flow rate of the natural gas is monitored as it is distributed to the injectors.

Controlling the injector timing may be accomplished by 1) modifying the program in the existing engine computer, 2) replacing the existing computer with another computer, or 3) integrating a new computer with the existing computer to take over the injector timing. Regardless of the method, the conversion may require additional wiring from the controlling computer(s) to the injectors and other devices in the vehicle (sensors, actuators, etc.).

According to an exemplary embodiment, a diesel engine to be converted may have an on-board diagnostic (OBD) system or control system, for example an OBD-II computer. In some exemplary embodiments, the OBD system may be coupled to one or more of the injectors, and may provide instructions to the injectors as to, for example, when to open, how long to stay open (based on, for example, an altitude or air pressure, outside ambient temperature, fuel type, whether the vehicle is under load, engine speed, compression ratio, engine stroke, or any other variable conditions), and so forth. In an exemplary embodiment wherein, an existing diesel engine is converted, the OBD system may be provided with new instructions as to how to control the injectors after the system has been converted, including, for example, instructions as to how to control the injectors when the system is in a startup phase and instructions as to how to control the injectors when the vehicle is past a startup phase and has moved to, for example, a standard burn cycle. The OBD system may also control, for example, the timing of the ignition of the natural gas, which may be triggered using the secondary starter plug, i.e. the pilot fluid. In an exemplary embodiment, a set of standard programs may be provided, each designed to reconfigure the OBD system of a particular engine or set of engines, which may be provided as part of a conversion kit, as may be desired.

TABLE A

| | Injection timing | Injection timing |
|---|---|---|
| | relative to TDC at | relative to TDC |
| | idle | at 1500 RPM |
| Gasoline Pilot | +5 degrees to 0 | +10 degrees to |
| Fuel Injector | degrees (before | −5 degrees |
| | TDC) | |
| Compressed | +10 degrees to +15 | +15 degrees to |
| NG Main Fuel | degrees | −15 degrees |
| Injector | | |

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for using a pilot fuel other than diesel to initiate combustion in a diesel engine converted to use natural gas, the method comprising:
monitoring, by a computer system, natural gas temperature near or at one or more injectors;
controlling, by the computer system, timing of ignition of the natural gas that is triggered using the pilot fuel; and
determining, by the computer system, an improvement in control of injector timing and amount of natural gas that is introduced to a cylinder based on the monitoring of natural gas temperature.

2. The method of claim 1 further comprising:
monitoring natural gas flow near or at the one or more injectors; and
determining an improvement in control of the injector timing and amount of natural gas that is introduced to the cylinder based on the monitoring of natural gas flow.

3. The method of claim 1 wherein the diesel engine includes an addition of one or more openings to allow insertion of the one or more injectors.
